(19) United States
(12) Patent Application Publication
(10) Pub. No.: US 2005/0222849 A1
(43) Pub. Date: Oct. 6, 2005

(54) Method for selling confectionery, method for providing information, method for selling advertising, and package to be used by a number of methods

(76) Inventor: Ulrik Skovgaard Rasmussen, Middlefart (DK)

Correspondence Address: CANTOR COLBURN, LLP, 55 GRIFFIN ROAD SOUTH, BLOOMFIELD, CT, 06002, US

(21) Appl. No.: 10/507,056

(22) PCT Filed: Mar. 8, 2002
(86) PCT No.: PCT/DK02/00156

§ 371 Date: May 2, 2005

(51) Int. Cl. G06F 17/60

(52) U.S. Cl. 705/1

(57) ABSTRACT

The invention relates to a method for selling confectionery, where the confectionery is combined with a package and is combined with information chosen among news, entertainment and advertising, in which package the confectionery is contained and on which package the information is provided, and where the package is provided with at least one outer surface and at least one inner surface, the at least one outer surface of said package includes information relating to the confectionery in the package and a substantial part of the inner surface of said package includes further information not relating to the confectionery, where the further information not related to the confectionery may vary among a number of packages, and, where the combination of the confectionery and the package and the information is purchased, the package is closed so that the inner surface is not visually accessible.

The present invention relates to a method for selling confectionery. The invention also relates to a method for providing information. Furthermore the invention relates to a package to be used by either of the methods.

### BACKGROUND OF THE INVENTION

U.S. Pat. No. 6,136,350 describes a method for selling chewing gum. The method involves printing indicia on the chewing gum with a print indicating a specific topic so that the chewing gum may be used as a play item related to the specific topic. As example, the printed indicia on the chewing gum may resample a check and the package in which the chewing gum is packed may resample a check book. Other examples are shown and described. The purpose of the method and of the examples is to promote the marketability of the chewing gum as a confectionery. However, some disadvantages in the promotion will occur. Firstly, the promotion has to be planned very early before the marketing of the chewing gum because the manufacturing process of the chewing gum must be adjusted to the actual promotion before the indicia can be printed on the chewing gum. Secondly, the cost of manufacture is very high in relation to the manufacture of chewing gum without indicia. And thirdly, the space needed on shelves at point of sales in retail shops is very different for each of the different chewing gums and their packages. This may cause a nuisance and a problem to the retail shops.

U.S. Pat. No. 5,125,689 describes a package for promotional or other articles for providing information that are to be concealed during purchase of the package. The package consists of a number of panels that are mutually connected along folding lines. The panels may be opened separately and successively in order for the information on the different panels to be viewed successively. As mentioned, the information may be of promotional kind or of other kinds such as lottery tickets or coupons. The front panel will have information related to the type of information on the inside of the panels. The package has the advantage that the customer cannot view the information on the inside of the panels during purchase. However, still some disadvantages are present. The customer knows what the information on the inside relates to, namely as example a certain lottery. Also, the object of purchase is the information solely. Thus, if the customer has no interest in the lottery or other promotional topic there are no other incentives for the customer to buy the package.

It is also commonly known to sell confectionary, morning cereals and other like products in combination with information not related to the product, Examples may be information cards or folders included separately in packages of morning cereals containing information on as example dinosaurs, sport idols, music entertainment and other topics being the field of interest of young people. However, all the packages has the disadvantage, that it is possible in the retail store to open the package, take out the information card or folder and close the package again in order to obtain the information only without having to purchase the product also. This is of course of no interest to the manufacturer of the product, who will have difficulties explaining to the consumer why the packages do not contain the separate information cards or folders often indicated on the outer surface of the package.

It is an object of the present invention to provide a method and a package to be used by the method, said method and package enabling a product such as a confectionery like chewing gum to be sold to a customer based on more causes than only to purchase the confectionery. Also, it is an object to provide a method and package enabling the manufacturer to base the purchase on different causes and even to base the purchase on causes not related to the confectionery itself. Finally, it is an object to provide a package, which cannot be the subject of stealing the information without having to purchase the whole package including the product and visa versa, which cannot be the subject of stealing the product without also purchasing the package including the information.

### SUMMARY OF THE INVENTION

This object is obtained by a method for selling confectionery where the confectionery is combined with a package and is combined with information chosen among news, entertainment and advertising, in which package the confectionery is contained and on which package the information is provided, and where said package is provided with an outer surface and an inner surface, the outer surface of said package at least comprising information related to the confectionery in the package and a substantial part of the inner surface of said package at least comprising information not related to the confectionery, where the information not related to the confectionery is different among a number of packages, and when the combination of the confectionery and the package and the information is being purchased, the package is closed so that the inner surface is not visually accessible.

The object of the invention may also be obtained by a method for providing information, where the information is chosen among news, entertainment and advertising and is combined with a package and is combined with a confectionery, in which package the confectionery is contained, and on which package the information is provided, and where said package is provided with an outer surface and an inner surface, the outer surface of said package at least comprising information related to the confectionery in the package and a substantial part of the inner surface of said package at least comprising information not related to the confectionery, where the information not related to the confectionery is different among a number of packages, and when the combination of the confectionery and the package and the information is being purchased, the package is closed so that the inner surface is not visually accessible.

By providing a combination of the confectionery, of the package and of the information several advantages are present at the same time irrespective of whether a consumer is 3 interested in only purchasing the confectionery or is interested in only getting the information. Alternatively, the consumer may primarily be interested in purchasing the confectionery and only secondarily interested in getting the information. Further alternatively, the consumer may primarily be interested in getting the information and only secondarily interested in purchasing the confectionery.

Firstly, because the confectionery is contained in the package and a substantial part of the information not related to the confectionery is provided on the inner surface of the package itself, there is no risk of the information being stolen without the confectionery being purchased. This may be accomplished although the consumer primarily may be interested in getting the information and perhaps is not interested at all in getting the confectionery or perhaps is only secondarily interested in getting the confectionery. Purchase of the confectionery despite a consumer primarily or perhaps only having an interest in getting the information is further ensured when the information, as stated, is provided on a substantial part of the inner surface.

Secondly, because the substantial part of the information not related to the confectionery is provided on the inner surface of the package, there is no risk of the consumer purchasing the confectionery and not getting the information, although the consumer primarily may have an interest in getting the confectionery and perhaps does not at all have an interest in getting the information or perhaps is only secondarily interested in getting the information. Getting the information despite a consumer primarily or perhaps only being interested in purchasing the confectionery is further ensured when the information, as stated, is provided on a substantial part of the inner surface.

Normally, both the manufacturing, the packaging and the distribution of the combination of the confectionery, the package and the information is made by and paid by the manufacturer of the confectionery. If, however, the information is important or is desirable for a supplier of other products or services than the confectionery to pass on to possible consumers of the confectionery, then all or some of the information provided on the package may be information on the business of the supplier, either information related to the supplier himself or information related to one or more products and/or services that the supplier supplies. Depending on the needs and wishes of the supplier of the other goods and/or services, then part of or all of the costs for manufacturing, for packaging and for distributing the combination of the confectionery, the package and the information may be paid by the supplier. This is especially advantageous when the method according to the invention is to provide information being advertising.

Thus, the object of the invention may also be obtained by a method for selling advertisement, where the information comprises a number of advertisements and is combined with a package and is combined with a confectionery, in which package the confectionery is contained, and on which package the information is provided, and where said package is provided with an outer surface and an inner surface, the outer surface of said package at least comprising information related to the confectionery in the package and a substantial part of the inner surface of said package at least comprising the number of advertisements, said advertisements not being related to the confectionery, where the number of advertisements not related to the confectionery optionally is different among a number of packages, and when the combination of the confectionery and the package and the information is being purchased, the package is closed so that the inner surface is not visually accessible.

The supplier of other goods and/or services is the person or company wanting to provide advertises to a certain group of possible customers. The supplier contacts the manufacturer of the confectionery or the manufacturer of the packages. The supplier may have a special advertisement or a special occasion, which the supplier wants to provide to a certain group of possible customers. This may be a group of young people at a musical concert, it may any people on a pedestrian street or it may be possible customers in a certain shop or other point of sale situation.

The supplier contributes to the method according to the invention by providing the information not related to the confectionery. The manufacturer of the confectionery contributes with the confectionery and the same person or another person contributes with the printed package. However, it is the supplier of the information not related to the confectionery who pays at least the distribution of the combination of the package, the information and the confectionery. Alternatively the supplier also or in stead pays the packing of the confectionery into the package, still alternatively the supplier also or in stead pays the manufacture of the package, still alternatively the supplier also or in stead pays the printing of the package and still alternatively the supplier also or in stead pays the manufacture of the confectionery.

Accordingly, the manufacturer of the confectionery for the combination of the confectionery, the package and the information may have the costs of production paid. The manufacturer of the package and the person printing the package for the combination of the confectionery, the package and the information may also have the costs of production paid. The supplier of the information obtains a new means for providing information in exchange of paying either some or all of the costs for providing the other features of the combination of the confectionery, the package and the information, i.e. features other than the information not related to the confectionery.

Thereby, the primary object of the consumer for purchasing the combined confectionery,) package and information may be to get the confectionery, the primary object of the manufacturer for manufacturing and distributing the combined confectionery, package and information may be to sell more confectionery or a new type of confectionery, and the primary object of the supplier of the other goods and/or services than the confectionery for distributing and optionally selling the combined confectionery, package and information 5 may be to provide the information not related to the confectionery.

The term information can mean any kind of text, pictures, sounds or other means of communication of knowledge to a person or machine that are to receive the knowledge, said knowledge concerning a particular fact or a particular circumstance.

A package according to the invention is intended for containing confectionery and where said package is provided with an outer surface and an inner surface, the outer surface of said package at least comprising information related to the confectionery intended to be contained in the package and the inner surface of said package at least comprising information not related to the confectionery, and where the information not related to the confectionery at least comprises information chosen among information on news, entertainment and advertising.

By having information related to the confectionery to be contained in the package and by also having information not related to the confectionery and by having information provided on the outer surface and the inner surface of the package, as stated, several possibilities exist of either primarily selling confectionery or providing information or, alternatively, of primarily both selling confectionery and providing information.

In a preferred embodiment of a package according to the invention, the information related to the confectionery at least comprises the trade name of the confectionery, preferably also comprises trademarks and other trade features related to the confectionery: In a more preferred embodiment of a package according to the invention, the information related to the confectionery also comprises information as demanded by law concerning ingredients and the like information on the confectionery. In an even more preferred embodiment of a package according to the invention, the information not related to the confectionery is chosen among information on news, entertainment and advertising in certain fields of interests, said information being for example on sport, on music, on fashion, on games, on film, on news, on health, on communication, on education, on jobs, on love, on travel, on famous people, on parties etc.

Providing the information in this manner fulfils more objectives, both the objective of providing the information needed when marketing the confectionery in order to provide the consumer with information at least needed on the confectionery and also the objective of providing information as demanded by national or international law. However, furthermore there is the objective of providing information necessary for the combination of selling the confectionery and providing the information as mentioned above.

In a further, but alternative, embodiment of a package according to the invention, the information on the outer surface of the package also comprises information related to the information on the inner surface not related to the confectionery so that the outer surface of the package also comprises information not related to the confectionery and being related to the said information on the inner surface.

By providing information on the outer surface, said information relating to the information on the inner surface and not being related to the confectionery, it is possible to indicate to the consumer that the information on the inner surface is of a certain type such as various categories under news, entertainment or advertising or that the information on the inner surface is directed towards a certain field of interest such as sports, films etc. This may be used to ensure the consumer that the information on the inner surface and not related to the confectionery at least is information that will have an informational value to the consumer.

In a still further, but alternative, embodiment of a package according to the invention, the information on one of the surfaces, preferably on the inner surface, comprises information not related to the confectionery, and also comprises additional information related to the information not related to the confectionery, said additional information related to other media of information than the package. Preferably, the information on one of the surfaces, preferably on the inner surface, comprises information related to the confectionery, and also comprises additional information not related to the information related to the confectionery, said additional information related to other media sources of information than the package.

By providing additional information on one of the surfaces, said additional information being different from the previously mentioned information related to the confectionery and different from the previously mentioned information not related to the confectionery, it is possible to further enhance the informational value to the consumer of the information on the package. The additional information is related to other media of information than the package, thus linking the package as a media source with other media sources.

As example, the other media sources may be printed media sources such as newspapers being a news media, printed magazines being an entertainment media, posters being an advertising media etc, The other media sources may also be electronic media sources such as television and radio being electronically distributed news, electronic magazines i being electronically distributed entertainment, electronic web-sites, electronic wap-sites etc. Finally, still other media sources may be media sources contained in the package itself such as cards, folders, or the like bearing the additional information.

In a still further, but alternative, embodiment of a package according to the invention, the information on one of the surfaces, preferably on the outer surface, comprises information not related to the confectionery, and also comprises additional information related to the information not related to the confectionery, said additional information related to certain fields of interest. Preferably, the information not related to the confectionery is chosen among information on news, entertainment and advertising in certain fields of interests, said information being for example on sport, on music, on fashion, on games, on film, on news, on health, on communication, on education, on jobs, on love, on travel, on famous people, and on parties etc.

By also or alternatively providing additional information on one of the surfaces, said additional information being different from the previously mentioned information related to the confectionery and different from the previously mentioned information not related to the confectionery, it is possible to further enhance the informational value to the consumer of the information on the package. The additional information is related to one or more fields of interest, thus linking the package as a means of obtaining information with certain fields of interest related to consumers having a certain demographic profile.

The fields of interest may be interests common to one or more groups of consumers having a certain age, or may be interests common to female or male consumers, or may be interests common to other kinds of groups or segments dividing the population. As an example, the fields of interest could be related to youth having an age from 13 to 23 years of age because this group of population is a group having a high demand for confectionery such as chewing gum. At the same time, this group of population is also a group having a high demand for different information among news, entertainment and advertising on many different topics not related to the confectionery as such. The fields of interest may also be related to other groups having another higher age and having other, similar or same fields of interest as the formerly mentioned group.

The package is preferably either made of paper or cardboard or is made of plastic or is made of any combination of these materials. The package may also be made of other materials such as metal and wood although these materials are more rare when selling confectionery such as chewing gum. The information may either, and preferably, be printed directly on the material of which the package is made or may alternatively be printed on labels, which subsequently are secured to the package. Also, a combination of printing the information on the material of the package and printing the information on labels subsequently secured to the package can be effected.

In a first embodiment, the package consists of a number of integrated plane panels, said panels being divided by folding lines and being intended for mutually folding along the folding lines, and a number of said panels being provided with a first surface intended as an outer surface of the panels when the panels are mutually folded and a second surface intended as an inner surface when the panels are mutually folded, and where a pocket is provided by the panels at least when the panels are mutually folded, said pocket being intended for containing the confectionery.

A package consisting of individual panels mutually joined and folded along folding lines has the advantage that the package may have a limited thickness and preferably having the size of a small wallet, perhaps even just the size of a credit card. The amount of or the type of confectionery that the package can contain is however be limited. Nevertheless, bearing in mind that the package is intended for selling confectionery in combination with providing information not related to the confectionery, or that the package is intended for providing information not related to the confectionery in combination with the confectionery, then there is a secondary object of purchase being getting the information other than a primary object of purchase being purchasing the confectionery. This justifies a package only being capable of containing a limited amount of confectionery in comparison with the surface available for information not related to the confectionery.

In a second embodiment, the package consists of a number of sides of a box, said sides being divided by folding lines and being mutually folded in order to form the box, and a number of said sides being provided with a first surface intended as an outer surface of the sides when the sides are folded to form the box and a second surface intended as an inner surface when the sides are mutually folded to form the box, and where the box is provided by the sides when the sides are mutually folded, said box being intended for containing the confectionery.

A package consisting of a box has the advantage that the package may contain a larger amount of confectionery and may contain many different types of confectionery, either separately in each box or mixed in each box. The size of the box is larger than the above-mentioned package, at least a box has a greater thickness than the package made of panels. Nevertheless, bearing in mind that the package is intended for selling confectionery in combination with providing information not related to the confectionery or that the package is intended for providing information not related to the confectionery in combination with selling confectionery, then there is a primary object of purchase being purchasing the confectionery other than a possible second object of purchase being getting the information. This justifies a package being capable of containing a greater amount of confectionery in comparison with the surface available for information not related to the confectionery.

In a third embodiment, the package comprises a sheet, said sheet being intended for rolling around the confectionery as a wrapping, and the sheet being provided with a first surface intended as an outer surface of the wrapping when the sheet is wrapped round the confectionery and a second surface intended as an inner surface when the sheet is wrapped around the confectionery.

A package consisting of a roll having any cross-section such as a cross-section being round, oval, triangular, square etc. has the advantage that the package may contain a larger amount of confectionery and may contain different types of confectionery, preferably separately in each roll. The size of the roll is different than a package made of panels and than a box, at least a roll often has a greater length than the package made of panels or the package made as a box. Also, the roll has an integrate sheet wrapped around the confectionery, said integrate sheet having a large integrate surface compared to the size of the roll. Therefore, bearing in mind that the package is intended for selling confectionery in combination with providing information not related to the confectionery or that the package is intended for providing information not related to the confectionery in combination with selling confectionery, then there is an object of purchase being getting the information other than an object of purchase being purchasing the confectionery, However, each object may perhaps have the same preference to the consumer, which justifies a package being capable of containing an amount of confectionery not being excessively large or small in comparison to the surface available for information not related to the confectionery.

Other types of packages than integrated panels, boxes or rolls are possible in order to obtain packages having a specific appearance, having a specific shape or having a specific relation between the amount of confectionery contained in the package and the surface available for information not related to the confectionery.

In the above and in the following the invention is described with reference to confectionery in general. Confectionery is a very well suited product for utilising the methods according to the invention as confectionery never wilt be purchased out of necessity but perhaps will be purchased out of pleasure. However, a special kind of confectionery, namely chewing gum, is neither purchased out of necessity nor purchased out of pleasure. Chewing gum is purchased not for personal nutritional needs in order to survive and is not purchased for persona! pleasure without consideration to others needs and pleasures, but is purchased out of a wish for social acceptance in consideration of other persons view on your person, i.e. out of a personal wish for acceptance among other people.

When buying products of necessity the consumer buys the combination of the product and the package solely based on the object of purchase of getting the product irrespective of the package if the package does not offer any added value to the product. Thus, a consumer will not buy oranges in stead of lemons just because the oranges are packed in a package with information, which is more valuable to the consumer compared to any information on the package of lemons.

Nevertheless, a consumer may buy confectionery in general in stead of caramels if the confectionery as a general product satisfying a personal pleasure is packed in a package that offers information not related to the confectionery, which information is more valuable to the consumer compared to any information on the package of caramels.

An often preferred confectionery is chewing gum because this kind of confectionery is commonly known and used world-wide. However, as mentioned above, chewing gum is neither a product purchased solely out of a personal need and nor a product purchased solely out of a personal pleasure. Chewing gum may be characterised as a product in between these two formerly mentioned kinds of products, namely a confectionery having to serve a need for a satisfactory smell in order to gain the acceptance wanted among other people, but also a confectionery having to serve a need for a satisfactory taste in order to please the person chewing the chewing gum. Accordingly, normally when relating chewing gum to marketing, chewing gum will be a “low involvement” product. By utilising any of the methods according to the invention together with the package according to the invention, it is possible to change chewing gum to a product having a higher involvement when marketed. Chewing gum may even change to a “high involvement” product depending on the package and on the information not related to the confectionery.

However, any other kind of confectionery than chewing gum may be contained in the package according to the invention an also mixes of different kinds of confectionery may be used. Chewing gum just falls within a certain category of confectionery, which may be beneficial when utilising the methods according to the invention for selling confectionery or for providing information and when using the package according to the invention for selling confectionery.

Moreover, the invention relates to a confectionery packaging (40) comprising at least one pocket (403; 9) for receipt of confectionery,
said at least pocket comprising at least one breakable sealing (405)
said packaging (40) comprising at least two sections (401, 402)
said at least two sections (401, 402) forming a part of further releasable sealing.

According to the invention it is possible to obtain a packaging, which may fulfil both the mandatory requirements of containing and transportation of the confectionery from the manufacturing premises to the consumer.

Moreover, the packaging may be applied for a very advantageous keeping or storage of the confectionery after initial breaking of the at least one breakable sealing. According to a preferred embodiment of the invention the at least one breakable sealing may be a sealing, which may be broken once. According to a further embodiment of the invention, this at least one breakable sealing may comprise e.g. a releasable adhesive sealing.

The packaging of the invention provides a further releasable sealing, which may “take over”, when the first sealing has been broken, due to the fact that the at least two sections may be folded around the pocket and thereby providing sufficient sealing with respect to environmentally influences on the confectionery contained in the pocket.

According to the terms of the invention both conventional and medical chewing gum is also regarded as confectionery.

28 said further releasable sealing (401, 402) comprising at least one releasable adhesive (404).
adapted for fastening the at least two sections (401, 402) in a folded position around said at least one pocket (403) in at least one closed position.

According to an advantageous embodiment of the invention, the packaging may be applied for refill.

When said at least one breakable sealing (405) being releasable, a further advantageous embodiment of the invention has been obtained.

When said at least one breakable sealing (405) being non-releasable, a further advantageous embodiment of the invention has been obtained.

According to a preferred embodiment of the invention, the at least one breakable sealing may be non-releasable due to the fact that the further releasable sealing may “take over”, when the first sealing has been broken, due to the fact that the at least two sections may be folded around the pocket and thereby providing sufficient sealing with respect to environmentally influences on the confectionery contained in the pocket.

When said at least one pocket (403) being formed, preferably folded, by at least one first pocket section 4030 and at least one second pocket section 4031, a further advantageous embodiment of the invention has been obtained.

When at least one pocket (403) extending from an end of the packaging in its unfolded position towards the other end, and where said pocket comprising at least one opening (4032) is formed by the said by at least one first pocket section 4030, and where said at least one opening (4032) is mechanically stiffened by extending said at least one first pocket section (4030) beyond at least one folding line (4040) formed by said at least one first pocket section 4030, said at least one second pocket section (4031) and one of said at least two sections (401, 402), a further advantageous embodiment of the invention has been obtained.

According to a preferred embodiment the folding of the first pocket section over a folding line near to the opening of the pocket an advantageous “self-closing” effect of the pocket may be obtained, even within any kind of supplementary adhesives.

When said packaging comprising at least one surface (401, 402, 403) adapted for advertisement and where said at least one surface at least one of said sections (401, 402 is visually covered by at least one section of the packaging when the packaging is in its at least one folded position, and where said
said at least one surface is visible when the packaging is in at least one unfolded position, a further advantageous embodiment of the invention has been obtained.

When said package comprising a polymer, a further advantageous embodiment of the invention has been obtained.

According to a preferred embodiment of the invention the packaging may comprise conventional packaging materials, such as plastic, e.g. polystyrene material suitable for the purpose.

### BRIEF DESCRIPTION OF THE INVENTION

In the following the invention will be described more in detail with reference to the drawings, where

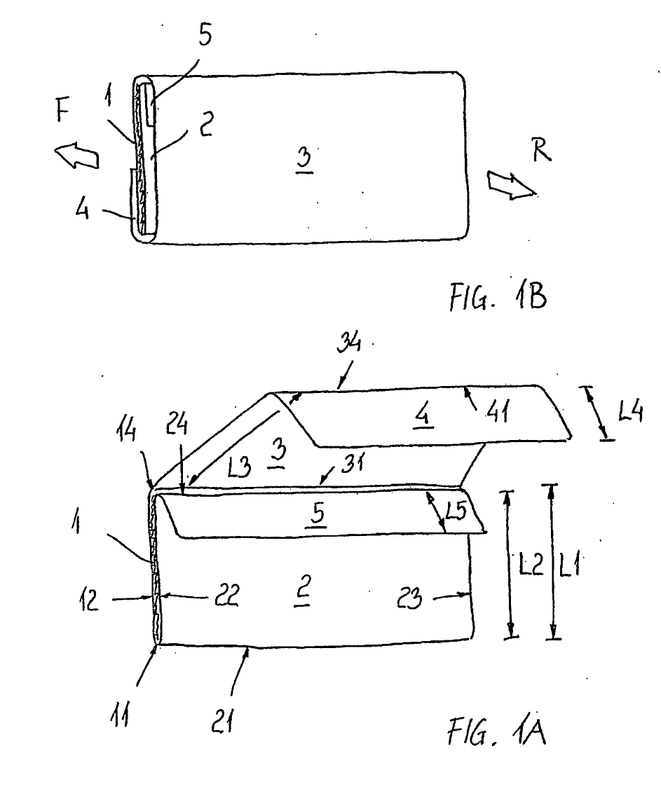

FIGS. 1A and 1B is a drawing of a first embodiment of a package to be used when selling confectionery in combination with providing information, alternatively when providing information in combination with confectionery,

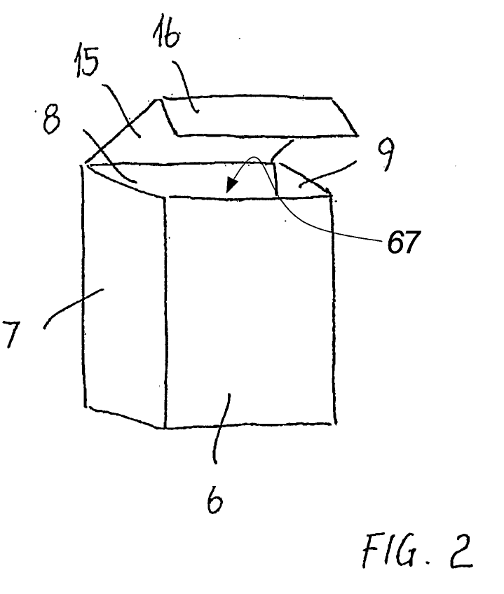

FIG. 2 is a drawing of a second embodiment of a package to be used when selling confectionery in combination with providing information, alternatively when providing information in combination with confectionery,

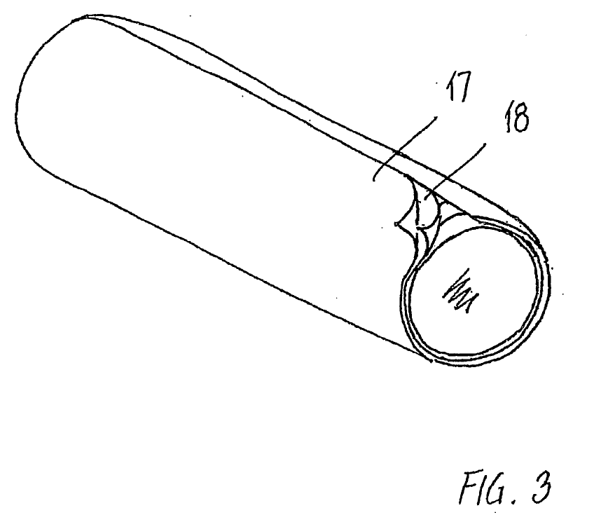

FIG. 3 is a drawing of a third embodiment of a package to be used when selling confectionery in combination with providing information, alternatively when providing information in combination with confectionery, and where

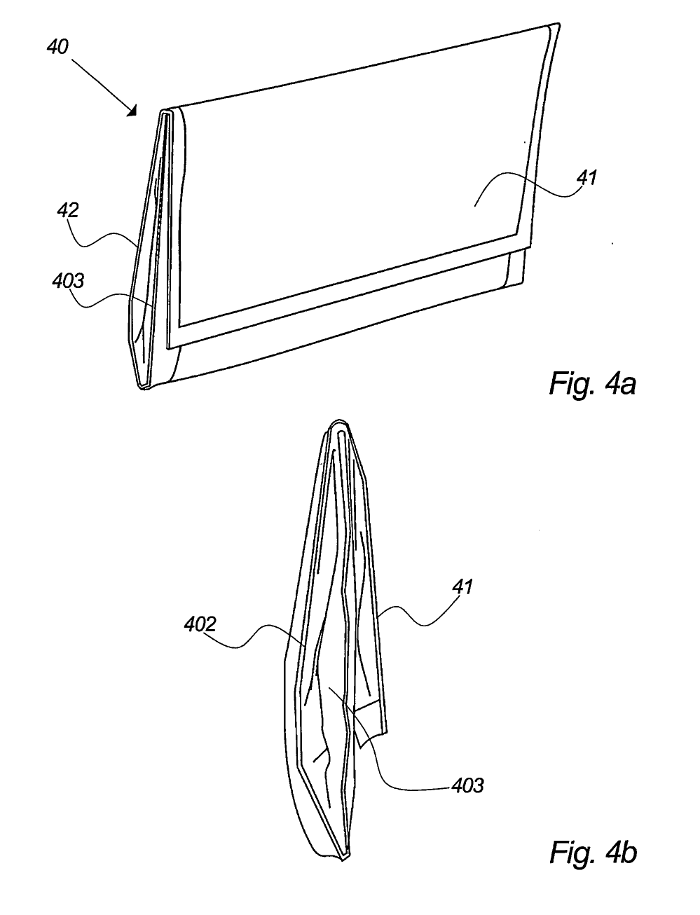

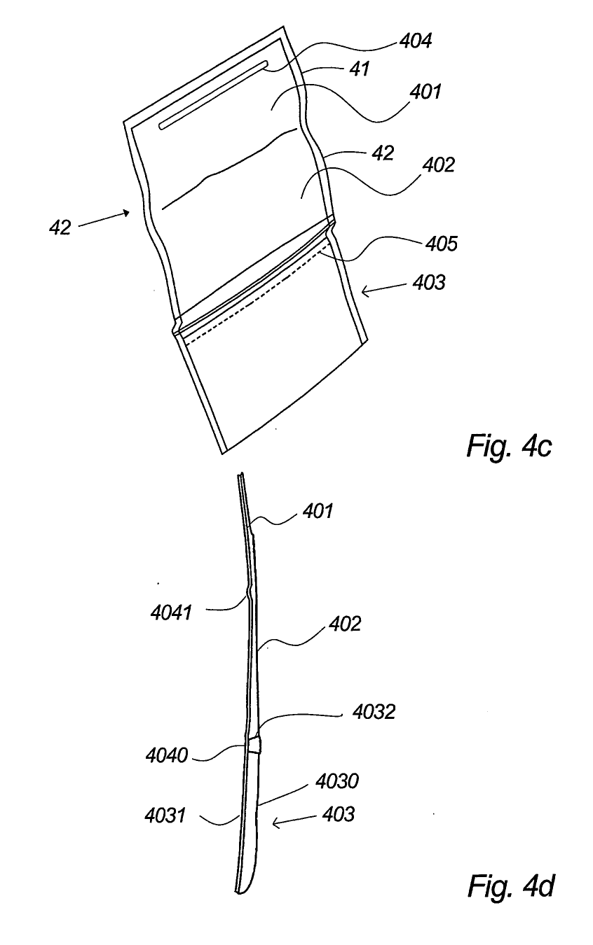

FIG. 4a-4d illustrate a further packaging according to an embodiment of the invention.

### DETAILED DESCRIPTION OF THE INVENTION

FIG. 1A and FIG. 1B shows a first and preferred embodiment of a package. The package consists of a number of panels which are mutually joined and which are mutually folded along folding lines. Additionally, a first panel 1 and a second panel 2 are mutually joined along a first edge 11 of the first panel 1 and a first edge 21 of the second panel 2, along a second edge 12 of the first panel 1 and a second edge 22 of the second panel 2 and along a third edges (not shown) of the first panel 1 and a third edge 23 of the second panel 2. The first edges 11,22 of the first panel 1 and of a second panel 2 constitute the mutual folding line between the panels 1,2. Fourth edges 14 and 24 of the first panel 1 and of the second panel 2 are not joined. Thereby a small pocket is formed between rear sides of the first panel 1 and of the second panel 2. In this small pocket any confectionery may be contained. The first panel 1 has a height L1 that is the same as or larger than a height L2 of the second panel 2.

A third panel 3 has a height L3 that is approximately the same as or larger than the height L2 of the second panel 2. A mutual folding line is established between the first panel 1 and the third panel 3 along the forth edge 14 of the first panel 1 and a first edge 31 of the third panel 3. The third panel 3 is intended for overlapping and thus covering the second panel 2 closed of the package as shown in FIG. 11B.

A fourth panel 4 has a height L4 that is approximately the same as or less than the height L1 of the first panel 1. A mutual folding line is established between the third panel 3 and the fourth panel 4 along a forth edge 34 of the third panel 3 and a first edge 41 of the fourth panel 4. The fourth panel 4 is intended for overlapping and thus covering an outer surface (nor shown) of the first panel 1 closed of the package as shown in FIG. 1B.

A fifth panel 5 is intended as a finger-grip for separating the fourth edges 14,24 of the first panel 1 and of the second panel 2, respectively. Separating the fourth edges 14,24 of these panels 1,2 makes it easier to gain access to the pocket and thereby getting the confectionery out of the pocket. In the embodiment shown, the fifth panel 5 has a height L5 that is smaller than the height L1 of the first panel 1.

All the five panels have an outer surface and an inner surface. The outer surface of the first panel is directed into the plane of the paper and the inner surface of the first panel is directed out of the plane of the paper. Above, the inner surface of the first panel is called the rear side of the first panel and constitutes part of the pocket for the confectionery. The outer surface of the second panel is directed out of the plane of the paper and the inner surface of the second panel is directed into the plane of the paper. Above, the inner surface of the first panel is called the rear side of the second panel and constitutes part of the pocket for the confectionery.

The outer surface of the third panel is in FIG. 1A directed into the plane of the paper and in FIG. 1B directed out of the plane of the paper. The inner surface of the third panel is in FIG. 1A directed out of the plane of the paper and in FIG. 1B directed into the plane of the paper. The outer surface of the fourth panel is in FIG. 1A directed out of the plane of the paper and in FIG. 1B directed into the plane of the paper. The inner surface of the fourth panel is in FIG. 1A directed into the plane of the paper and in FIG. 1B directed out of the plane of the paper. The outer surface of the fifth panel is in FIG. 1A directed out of the plane of the paper and in FIG. 1B directed into the plane of the paper. The inner surface of the fifth panel is in FIG. 1A directed into the plane of the paper and in FIG. 1B directed out of the plane of the paper. In the embodiment shown in FIG. 1B, the first edge 31 of the third panel is directed upwards in the position shown. This results in a fourth edge of the fourth panel directed upwards when the package is closed. However, in another and preferred position at a point of sale the first edge of the third panel is directed downwards, resulting in the fourth edge of the fourth panel also being directed downwards.

The inner surface of the first panel is the rear side of the panel. The inner surface of the first panel is not visible due to the rear side constituting part of the pocket. Similarly, the inner surface of the second panel is the rear side of the panel. Also, the inner surface of the second panel is not visible due to the rear side also constituting part of the pocket. Thus, preferably none of the inner surfaces of the first panel and of the second panel will have any information printed on the surface, because these surfaces are not visible, neither when the package is closed nor when the package is in an open state.

In the embodiment shown, the outer surface of the first panel is partly visible when the package is closed. A first part of the outer surface of the first panel constitutes a visible surface when the package is closed. This is the case, when the height L4 of the fourth panel is less than the height L1 of the first panel. This results in the first part of the first panel having a height corresponding to L1 minus L4 and being visible when the package is closed The first part of the first panel may have one kind of information printed on this part of the surface, preferably information not related to the confectionery in the package. Another second part of the first panel will not be visible when the package is closed because the fourth panel covers this second part of the outer surface of the first panel. The other second part of the first panel may have another kind of information, preferably also information not related to the confectionery.

The outer surface of the second panel is not visible when the package is closed. This surface is preferably provided with information not related to the confectionery. The outer surface of the third panel is fully visible when the package is closed. Accordingly, all or part of this surface may either be provided with information related to the confectionery or be provided with information not related to the confectionery or be provided with a combination of information related to the confectionery and information not related to the confectionery. The outer surface of the third panel is the next most visible surface when the package is closed. This surface constitutes a rear side of the package directed away from a possible consumer as shown by an arrow R when the package is closed and when the package is placed in at a point of sale. Also, in the embodiment shown, this surface is the largest visible one surface when the package is closed because the length L3 of the third panel is larger than the length L4 of the fourth panel.

The most visible surfaces when the package is closed are an outer surface of the fourth panel together with the first part of the outer surface of the first panel, the part not being covered by the fourth panel. These two surfaces constitute the front side of the package when the package is closed and is placed in at a point of sale turned towards a possible consumer as shown with the arrow F. Accordingly, at least one of these surfaces, preferably the outer surface of the fourth panel, are provided with information related to the confectionery. The first part of the outer surface of the first panel not covered by the fourth panel may be provided with either further information related to the confectionery or with information not related to the confectionery or with a combination of information related to the confectionery and information not related to the confectionery.

The inner surface of the third panel and the inner surface of the fourth panel are not visible when the package is closed. During opening of the package from the closed state to a fully open state, first during a partly opening of the package the inner surface of the 35 fourth panel becomes visible. Subsequently, during a further opening of the package to a fully open state, the inner surface of the third panel will become visible. These surfaces are preferably provided with information not related to the confectionery. Also, during opening of the package, at the same time as the inner surface of the fourth panel becomes visible also the second part of the outer surface of the first panel becomes visible. Furthermore, during further opening of the package to the fully open state, at the same time as the inner surface of the third panel becomes visible, also the outer surface of the second panel becomes visible.

The two-stage opening of the above-mentioned surfaces makes it possible to divide the information on each of these surfaces between one kind of information and another kind of information but both kinds of information related to the same topic. This constitutes a “surprising” effect or a “curiosity” effect. The information on the inner surface of the fourth panel may urge the consumer to subsequently view the information on inner surface of the third panel. Alternatively, the information on the inner surface of the fourth panel may relate to another topic than the information on the inner surface of the fourth panel.

Similarly, the information on the outer surface of the first panel, which is covered by the fourth panel when the package is closed, may urge the consumer to subsequently view the information on the outer surface of the second panel. Alternatively, the information on the outer surface of the first panel may relate to another topic than the information on the outer surface of the second panel.

The information on an inner surface of the fifth panel and the outer surface of the fifth panel may also have a “surprising” effect or a “curiosity” effect arising when the fifth panel is used as a finger grip for separating the fourth edges of the first panel and the second panel. Any of such effects should provide the consumer with an added value in comparison to just getting the confectionery and the information related to the confectionery. The information on the surfaces of the fifth panel may relate either to the confectionery or may not relate to the confectionery. Because the surfaces of the fifth panel are relatively small, then perhaps the outer surface of the fifth panel may be blank and thus not provided with information, while preferably the information on the inner surface, which becomes visible only when the fifth panel is gripped by the fingers, may relate to the confectionery.

In the following possible examples of the information provided on each of the surfaces of each of the panels are described. All the examples must not be construed as limiting other possible examples of information provided on the surfaces of the panels.

The outer surface of the third panel, which as mentioned is the largest visible one surface when the package is closed, but which, as mentioned, is only the next most visible surface when the package is in a point of sale situation, may be provided with information only relating to the confectionery. The information may be information which is voluntary and information as demanded by law. The information may be selected from information on the type of and on the amount of confectionery in the package, information on the ingredients and the amount of each ingredient of the confectionery, information on the content of energy and the content of different sources of energy in the confectionery, information on manufacturer or the distributor of the confectionery, information with the price or a bar code incorporating the price of the package with confectionery, and information with warnings or advises related to the use of the confectionery or the use of the package.

The outer surface of the fourth panel is one of the surfaces being most visible when the package is closed at a point of sale with this surface being displayed to the consumer.) Accordingly, as the outer surface of the first panel is provided with information related to the product but being of very informative character, then the outer surface of the fourth panel may be provided with information related more to marketing of the confectionery, and preferably provided with information on the trade name and/or trademark of the confectionery.

The first part of the outer surface of the second panel is the other most visible surface when the package is closed at a point of sale with this surface also being displayed to the consumer. Accordingly, as the outer surface of the fourth panel is provided with information related to the confectionery, then the first part of the second panel may be provided with information not related to the confectionery and preferably related to the information also not related to the confectionery and provided on the inner surface of one or more of the other panels.

Thereby, when purchasing the package in combination with the confectionery and the information, and where the information on the first part of the outer surface of the second panel is visible when purchasing the package, then the information on this surface may give a hint to the kind of information on the inner surfaces of one or more of the other panels. The kind of information on the inner surfaces of other panels and the information in the first part of the outer surface of the second panel is preferably divided into groups of information related to fields of interest. Thus, the information may be on sport, on music, on fashion, on games, on film, on news, on health, on communication, on education, on jobs, on love, on travel, on partying, on famous people, on transportation, on babies and children, and on history and religion or any other fields of interest. The field of interest may be printed on the first part of outer surface of second panel, and specific information on the field of interest may be printed on one or more of the inner surfaces of other panels.

The inner surface of the fourth panel is not visible when the package is closed, which is also the state at a point of sale, but is abutting the second part of the outer surface of the second panel. Thus, the inner surface of the fourth panel is preferably to be provided with information not related to the confectionery. The information provided on the inner surface of the fourth panel and not related to the confectionery is perhaps information in the field of interest printed on the first part of the outer surface of the second panel.

The information on the inner surface of the fourth panel may be of more informative character within the field of interest such as personal data of a music star, of a sport idol or of other people or topics. Also, the information on the inner surface of the fourth panel is preferably a combination of textual matter and photographic matter. Alternative to the information being on persons or topics, then the information may be advertises or news within the field of interest.

The inner surface of the third panel is neither visible when the package is closed, which is also the state at a point of sale, but is abutting the outer surface of the second panel. Thus, also the inner surface of the third panel is preferably to be provided with information not related to the confectionery. The information provided on the inner surface of the third panel and not related to the confectionery is perhaps also information in the field of interest printed on the first part of the outer surface of the second panel.

The information on the inner surface of the third panel may be of more entertaining character but still of a somewhat informative character within the field of interest such as the career of a music star, of a sport idol or of other people or the course of events of topics. Also, the information on the inner surface of the third panel is preferably a combination of textual matter and photographic matter. Alternative to the information being on persons or topics, then the information may be advertises or news within the field of interest. Furthermore, the information on the inner surface of the third panel preferably relates to the information on the inner surface of the fourth panel.

The outer surface of the second panel is neither visible when the package is closed, which is also the state at a point of sale, but is covered by the third panel. Thus, also the outer surface of the second panel is preferably to be provided with information not related to the confectionery. The information provided on the outer surface of the second panel and not related to the confectionery is perhaps and preferably also information in the field of interest printed on the first part of the outer surface of the second panel.

The information on the outer surface of the second pane may also be of more entertaining character but still of a somewhat informative character within the field of interest such as the career of a music star, of a sport idol or of other people or the course of events of topics. Also, the information on the outer surface of the second panel is preferably a combination of textual matter and photographic matter. However, preferably, instead of the information being on persons or topics, then the information is advertises or news within the field of interest. Thus, the information on the outer surface of the second panel preferably relates to the information on the first part of the outer surface of the first panel.

The second part of the outer surface of the first panel is neither visible when the package is closed, which is also the state at a point of sale, but is covered by the fourth panel. Thus, also the second part of the outer surface of the first panel is preferably to be provided with information not related to the confectionery. The information provided on the second part of the outer surface of the first panel and not related to the confectionery is perhaps and preferably also information in the field of interest printed on the first part of the outer surface of the second panel.

The information on the second part of the outer surface of the first panel may also be information related to other media sources of information than the media source which the package constitutes. The information related to the other media sources is preferably of informative character within the field of interest such as one or more addresses of retail dealers with goods related to the field of interest, or numbers of telecommunication to stores with goods related to the field of interest or addresses on the internet to web-sites with information or offers related to the field of interest. The information on the second part of the outer surface of the first pane is preferably only of textual matter, but may also include photographic matter. However, instead of the information being on either physical addresses, telecommunication numbers or electronic addresses, then the information may be advertises or news within the field of interest or even contest or the like. Thus, the information on second part of the outer surface of the first panel may relate to but need not relate to the information on the first part of the outer surface of the first panel. A primary object of the second part of the outer surface of the first panel is to inform of other media sources than the package.

The fifth panel can have several purposes and may either and preferably be provided with 1 information related to the confectionery, but may also be provided with information not related to the confectionery. Preferred information on either the outer surface or the inner surface or both the outer and inner surface is information similar to or identical to the information on the outer surface of the fourth panel, thus preferably the trade name and/or the trademark of the confectionery or the manufacturer of the confectionery.

Thereby, a informational connection is established between the initial surface that the customer sees before buying the combination of the package, the confectionery and the information and the final surface that the customer sees after having bought the package and just before separating the fourth edges of the first panel and the second panel in order to gain access to the pocket established between these panels and finally get the confectionery contained in the pocket.

Conclusively, the information on the outer surfaces of the sides of the box and the outer surfaces of the lid and the flap is preferably information not related to the confectionery in the box. Furthermore, the information on the outer surfaces of the sides of the box and of the lid and the flap is preferably information only related to the confectionery in the box or information not related to the confectionery or a combination of the information related to and the information not related to the confectionery.

FIG. 2 shows a second and alternative embodiment of a package. The package consists of a number of sides of a box, in the embodiment shown four sides 6-9, said sides being mutually folded along folding lines. Additionally, the sides are mutually joined along edges in order to constitute the box. Thereby, an interior of the box is made between rear sides¹ of the sides constituting the box. In this box any confectionery may be contained. The box has a height H, a width W and a depth D.

A fifth side 15 constitutes a lid of the box. The lid is joined with an upper edge of a rear side of the box, and a folding line is established between the rear side and the lid. The lid is provided with a flap 16, which is intended for insertion into the box abutting an inner surface of a front side of the box. The flap is mutuallyjoined with the lid along a folding line. All or some of the sides that are mutually joined may be joined in a manner that makes it possible easy and without destroying the material that the box is made of to separate the joining of the sides. Thereby, the box may be partly of fully unfolded in order to view one or more inner surfaces of the sides of the box. However, the unfolding of the box can only take place when all the confectionery is eaten, otherwise the confectionery cannot be contained in the box when the sides of the box have been unfolded.

In an embodiment of the box, the inner surfaces of the sides of the box may be completely or partly blank and thus not be provided with information at all or only being provided with information on part of the inner surfaces. This is especially desirable if the confectionery may leave traces of fatty substances, traces of colour or other traces, which may limit or eliminate the legibility of any information on the inner surfaces of the sides of the box.

Alternatively and in the this case preferably, an inner wrapping may be provided, said inner wrapping constituting a barrier between the confectionery in the box and the inner surfaces of the box so that the confectionery is not in contact with the inner surfaces of the box.

As is the case with the package as shown in FIG. 3 as described above, the information on the outer surfaces of the sides of the box and the outer surfaces of the lid and the flap is preferably information not related to the confectionery in the box. Furthermore, the information on the outer surfaces of the sides of the box and of the lid and the flap is preferably information only related to the confectionery in the box or information not related to the confectionery or a combination of the information related to and the 5 information not related to the confectionery.

The package of FIG. 3 comprises an opening 67.

FIG. 3 shows a third and further alternative embodiment of a package. The package consists of a roll with at least one wrapping 17, preferably two wrappings 17 and 18, an outer wrapping 17 and an inner wrapping 18. In the embodiment shown, the roll has a circular cross section. Other cross sections than circular such as oval, triangular, square or even other cross sections are possible. The wrapping is joined along border edges of the wrapping so that the wrapping enclose the roll of confectionery. Preferably, the roll has an inner wrapping for holding pieces of the confectionery gathered, and an outer wrapping wrapped around the inner wrapping. In this inner wrapping and outer wrapping the confectionery is contained. The roll has a length L, a circumference C and a diameter D.

Both the inner wrapping and the outer wrapping have an inner surface and an outer surface. The outer surface of the outer wrapping at least contains information related to the confectionery, said information being selected among the kind of information as described with reference to FIG. 1. The inner surface of the outer wrapping, the outer surface of the inner wrapping and the inner surface of the inner wrapping may be provided either with information related to the confectionery or with information not related to the confectionery or with a combination of information related to an information not related to the confectionery.

In an embodiment, the inner surface of the inner wrapping may be blank and thus not be provided with information at all. This is especially desirable if the confectionery may leave traces of fatty substances, traces of colour or other traces, which may limit or eliminate the legibility of any information on the inner surface of the inner wrapping. Alternatively and in the this case preferably, the inner wrapping is provided only for constituting a barrier between the confectionery in the roll and the inner surface of the outer wrapping that the confectionery is not in contact with the inner surface of the outer wrapping.

As is the case with the package as shown in FIG. 1 and FIG. 2 as described above, the information on the inner surface of the outer wrapping and the inner surface of the inner wrapping is preferably information not related to the confectionery in the box. Furthermore, the information on the outer surfaces of at least the outer wrapping is preferably information only related to the confectionery in the box or a combination of the information related to and the information not related to the confectionery.

FIG. 4a-4d illustrate a further advantageous embodiment of the invention.

The illustrated bag may e.g. be applied as a packaging for chewing gum.

The FIG. 4a illustrate a perspective view of a confectionery packaging 40 comprising at least one pocket 403 for receipt of confectionery.

The pocket comprises at least one breakable sealing 405, illustrated in FIG. 4c.

The packaging 40 comprises at least two sections 41, 42 said at least two sections 41, 42 forming a part of further releasable sealing.

According to the invention it is possible to obtain a packaging, which may fulfil both the mandatory requirements of containing and transportation of the confectionery from the manufacturing premises to the consumer.

FIG. 4b illustrates the packaging 40 seen from one side.

The packaging may be applied for a very advantageous keeping or storage of the confectionery after initial breaking of the at least one breakable sealing. According to a preferred embodiment of the invention the at least one breakable sealing may be a sealing, which may be broken once. According to a further embodiment of the invention, this at least one breakable sealing may comprise e.g. a releasable adhesive sealing.

The packaging of the invention provides a further releasable sealing, which may “take over”, when the first sealing has been broken, due to the fact that the at least two sections may be folded around the pocket and thereby providing sufficient sealing with respect to environmentally influences on the confectionery contained in the pocket.

According to the terms of the invention both conventional and medical chewing gum is also regarded as confectionery.

The sections 41 and 42 forms a further releasable sealing 41, 42 comprising at least one releasable adhesive 404 adapted for fastening the at least two sections 41, 42 in a folded position around said at least one pocket 403 in at least one closed position.

According to an advantageous embodiment of the invention, the packaging may be applied for refill.

Said at least one breakable sealing 405 illustrated on FIG. 404 may be releasable or non-releasable.

According to a preferred embodiment of the invention, the at least one breakable sealing may be non-releasable due to the fact that the further releasable sealing may “take over”, when the first sealing has been broken, due to the fact that the at least two sections may be folded around the pocket and thereby providing sufficient sealing with respect to environmentally influences on the confectionery contained in the pocket.

The at least one pocket 403 is formed, preferably folded, by at least one first pocket section 4030 and at least one second pocket section 4031 as illustrated in FIG. 4d.

The at least one pocket 403 extends from an end of the packaging in its unfolded position towards the other end, and where the pocket comprises at least one opening 4032 is formed by the said by at least one first pocket section 4030, and the at least one opening 4032 is mechanically stiffened by extending said at least one first pocket section 4030 beyond at least one folding line 4040.

The folding line is formed by said at least one first pocket section 4030, said at least one second pocket section 4031 and the section 4032.

According to a preferred embodiment the folding of the first pocket section over a folding line near to the opening of the pocket an advantageous “self-closing” effect of the pocket may be obtained, even within any kind of supplementary adhesives.

As mentioned with respect for FIG. 1 to 3 the packaging may comprise at least one surface 401, 402, 403 adapted for advertisement as illustrated in FIG. 4c.

The at least one surface, here surfaces 401, 402, 403 are visually covered by at least one section of the packaging when the packaging is in its at least one folded position as illustrated in FIG. 4a and FIG. 4b. and the at least one surface, here surfaces 401, 402, 403, is visible when the packaging is in at least one unfolded position, a further advantageous embodiment of the invention has been obtained as illustrated in FIGS. 4c and 4d.

When said package comprising a polymer, a further advantageous embodiment of the invention has been obtained.

According to a preferred embodiment of the invention the packaging may comprise conventional packaging materials, such as plastic, e.g. polystyrene material suitable for the purpose.

### Examples of Utilising the Package According to the Invention

In the following different examples are described of utilising any of the embodiments of a package according to the invention in combination with either of the methods according to the invention.

A primary way of utilising the package is for primarily selling confectionery, but promoting the confectionery by combing the confectionery with a package containing certain information. Thereby, a new means of selling confectionery is established in relation to just selling confectionery in packages only provided with information related to the confectionery or only provided with information either related to the confectionery or not related to the confectionery or a combination of such different kind of information, but where all the information is provided at the outer surfaces of the package.

Thus, by providing information not related to the confectionery and providing at least some of the information, and preferably most of the information, on the inner surfaces of the package, then the primary object of a consumer for buying the combination of the confectionery, the package and the information is to get the confectionery, and a secondary object of the consumer is to get the information on the inner surfaces of the package.

If the information is more important for the consumer to get than to get the confectionery, either because the information is highly relevant to the consumer or because the information contains many or recent news on a certain person or a certain topic within a certain field of interest, then the primary object of the consumer to purchase the confectionery may be to get the package with the information on the inner surfaces, and a secondary object of the consumer may then be to get the confectionery.

Furthermore, the information not related to the confectionery may, as mentioned, refer to other media sources than the package. Thus, the supplier of other goods and/or services may be other media sources so that the other goods and/or services need not be selling or providing these other goods or services, but may be advertising other media sources where other goods and/or services are sold or provided. Thus, the package with the information not related to the information may only be one media sources referring to another media source, but where the purpose of referring to the other media source is to promote other services and/or goods which the other media source provide information about.

Other media sources which the package according to the invention may provide information about can be any of the media sources such as newspapers, printed magazines, posters, electronic magazines, television, radio, electronic web-sites and electronic wap-sites.

The information not related to the confectionery may be chosen in different ways among news, entertainment and advertising. Preferably, the information is directed towards consumers having certain fields of interest such as information on sport, on music, on fashion, on games, on film, on news, on health, on communication, on education, on jobs, on love, on travel, on famous people and on party. These fields of interest are as an example typical for youth from 10-15 to 20-25 years of age. Some of these fields of interest together with information on other fields of interest such as information on transportation, on babies and on children are typical field of interest of mid-aged from 20-25 to 40-50 years of age. Still some of the before-mentioned fields of interest together with information on still other fields of interest such as information on history and on religion are typical field of interest of elderly from 40-50 years of age and older.

1. A method for selling confectionery, comprising:
combining confectionery with a package and information not related to the confectionary comprising at least one of news, entertainment and advertising, in which package the confectionery is contained and on which package the information is provided;
providing said package with at least one outer surface and at least one inner surface, the at least one outer surface of said package comprising information relating to the confectionery in the package and a substantial part of the inner surface of said package comprising further information not relating to the confectionery, where the further information not related to the confectionery may vary among a number of packages; and
closing the package where the combination of the confectionery and the package and the information is being purchased so that the inner surface is not visually accessible.

2. A method according to claim 1, where the combination of the confectionery and the package and the information is purchased by a consumer based on a primary condition being to obtain the information not related to the confectionery.

3. A method for providing information, where the information is comprises at least one of news, entertainment and advertising, the method comprising:
combining the information with a package and with a confectionery, in which package the confectionery is contained, and on which package the information is provided; and
providing said package with an outer surface and an inner surface, the outer surface of said package comprising information related to the confectionery in the package and a substantial part of the inner surface of said package comprising the information not related to the confectionery;
wherein the information not related to the confectionery is different among a number of packages; and
wherein when the combination of the confectionery and the package and the information is being purchased, the package is closed so that the inner surface is not visually accessible.

4. A method according to claim 3, where the combination of the confectionery and the package and the information is purchased by a consumer based on a primary condition being to obtain the information not related to the confectionery.

5. A method for selling advertisement, comprising:
combining a number of advertisements and with a package and with a confectionery, in which package the confectionery is contained, and on which package the advertisements are provided, and where
providing said package with an outer surface and an inner surface, the outer surface of said package at least comprising information related to the confectionery in the package and a substantial part of the inner surface of said package comprising the number of advertisements, said advertisements not being related to the confectionery;
wherein the number of advertisements not related to the confectionery optionally is different among a number of said packages, and
wherein when the combination of the confectionery and the package and the information is being purchased, the package is closed so that the inner surface is not visually accessible.

6. A method according to claim 1, wherein the information related to the confectionery is information provided by a supplier of the confectionery, wherein the information not related to the confectionery is information provided by a supplier of other products or services than the confectionery, and wherein the costs of at least manufacturing the package is paid by the supplier of the other products or services.

7. A package, for containing confectionery, comprising:
an outer surface and an inner surface, the outer surface of said package comprising information related to the confectionery intended to be contained in the package and the inner surface of said package comprising information not related to the confectionery; wherein the information not related to the confectionery comprises information on at least one of news, entertainment and advertising.

8. A package according to claim 7, where the information related to the confectionery comprises a trade name of the confectionery, trademarks, and/or other trade features related to the confectionery.

9. A package according to claim 7, where the information related to the confectionery also comprises information as demanded by law concerning ingredients.

10. A package according to claim 7, where the information not related to the confectionery is chosen among information on news, entertainment and advertising in certain fields of interests, said information being on sport, on music, on fashion, on games, on film, on news, on health, on communication, on education, on jobs, on love, on travel, on stars and on party.

11. A package according to claim 7, where the information on the outer surface of the package also comprises information related to the information on the inner surface not related to the confectionery.

12. A package according to claim 7, where the information on one of the inner and outer surfaces comprises information not related to the confectionery, and also comprises additional information related to the information not related to the confectionery, said additional information related to other media of information than the package.

13. A package according to claim 7, where the information on one of the surfaces comprises information related to the confectionery, and also comprises additional information not related to the information related to the confectionery, said additional information related to other media sources of information than the package.

14. A package according to claim 13, where the other media sources of information comprises specific media sources of information including at least one of newspapers, printed magazines, posters, electronic magazines, television, radio, electronic web-sites and electronic wap-sites.

15. A package according to claim 7, where the information on one of the inner and outer surfaces, preferably on the outer surface, comprises information not related to the confectionery, and also comprises additional information related to the information not related to the confectionery, said additional information related to certain fields of interest.

16. A package according to claim 15, where the information not related to the confectionery is chosen among information on news, entertainment and advertising in certain fields of interests, said information being on sport, on music, on fashion, on games, on film, on news, on health, on communication, on education, on jobs, on love, on travel, on famous people and on party.

17. A package according to claim 7, where the package is made of at least one of paper, cardboard, or plastic where the confectionery is chewing gum, where at least part of the information related to the confectionery is provided by printing the information on the outer surface of the package, and where at least part of the information not related to the confectionery is provided by printing on the inner surface of the package.

18. (canceled)

19. A package according to any of claim 7, where the package is made of plastic, where the confectionery is chewing gum, where at least part of the information related to the confectionery is provided by printing on a label secured to the outer surface of the package, and where at least part of the information not related to the confectionery is provided by printing on a label secured to the inner surface of the package.

20. A package according to claim 17, where the information related to the confectionery and being provided on the outer surface of the package, at least contains information on a possible sweetening agent in the chewing gum and preferably also on other possible additives in the chewing gum.

21. A package according to claim 17, where the information not related to the confectionery and being provided on the inner surface of the package, at least contains information directed towards fields of interest of youth from 10-15 to 20-25 years of age, comprising at least one of sport, music, film, education, transportation, health and electronic products.

22. A package according to claim 17, where the information not related to the confectionery and being provided on the inner surface of the package, at least contains information directed towards fields of interest of mid-aged from 20-25 to 40-50 years of age comprising at least one of sport, music, film, news, holidays, cars, health, babies and children and electronic products.

23. A package according to claim 17, where the information not related to the confectionery and being provided on the inner surface of the package, at least contains information directed towards fields of interest of elderly from 40-50 years of age or older comprising at least one of music, history, news, holidays, cars and electronic products.

24. A package according to claim 7, where the package further comprising a number of Integrated plane panels, said panels being divided by folding lines and being intended for mutually folding along the folding lines, and a number of said panels being provided with a first surface intended as the outer surface when the panels are mutually folded and a second surface intended as the inner surface when the panels are mutually folded, and where a pocket is provided by the panels at least when the panels are mutually folded, said pocket being intended for containing the confectionery.

25. A package according to claim 7, further comprising a number of sides of a box, said sides being divided by folding lines and being mutually folded in order to form the box, and a number of said sides being provided with a first surface intended as the outer surface when the sides are folded to form the box and a second surface intended as the inner surface when the sides are mutually folded to form the box, and where the box is provided by the sides when the sides are mutually folded, said box being intended for containing the confectionery.

26. A package according to claims 7, further comprising a sheet, said sheet being intended for rolling around the confectionery as a wrapping, and the sheet being provided with a first surface intended as an outer surface of the wrapping when the sheet is wrapped round the confectionery and a second surface intended as an inner surface when the sheet is wrapped around the confectionery.

27. Confectionery packaging comprising:
at least one pocket for receipt of confectionery, said pocket comprising at least one breakable sealing; and
at least two sections forming a part of further releasable sealing.

28. Confectionery packaging according to claim 27, wherein said further releasable sealing comprising at least one releasable adhesive adapted for fastening the at least two sections in a folded position around said at least one pocket in at least one closed position.

29. Confectionery packaging according to claim 27, wherein said at least one breakable sealing is releasable.

30. Confectionery packaging according to claims 27, wherein said at least one breakable sealing is non-releasable.

31. Confectionery packaging according to claim 27, wherein said at least one pocket is formed, preferably folded, by at least one first pocket section and at least one second pocket section.

32. Confectionery packaging according to claims 27, wherein
the at least one pocket extends from an end of the packaging in an unfolded position towards an other end, said pocket comprising at least one opening formed by at least one first pocket section, and where said at least one opening is mechanically stiffened by extending said at least one first pocket section beyond at least one folding line formed by said at least one first pocket section, said at least one second pocket section and one of said at least two sections.

33. Confectionery packaging according to claim 27, wherein
said at least one surface adapted for advertisement, wherein said at least one surface is visually covered by at least one of the sections of the packaging when the packaging is in a-folded position, and wherein said said at least one surface is visible when the packaging is in the unfolded position.

34. Confectionery packaging according to claim 27 33, wherein
said package comprising a polymer.

35. A method according to claim 3, wherein the information related to the confectionery is information provided by a supplier of the confectionery, wherein the information not related to the confectionery is information provided by a supplier of other products or services than the confectionery, and wherein the costs of at least manufacturing the package is paid by the supplier of the other products or services.

36. A method according to claim 5, wherein the information related to the confectionery is information provided by a supplier of the confectionery, wherein the information not related to the confectionery is information provided by a supplier of other products or services than the confectionery, and wherein the costs of at least manufacturing the package is paid by the supplier of the other products or services.

37. A package according to claim 19, where the information related to the confectionery and being provided on the outer surface of the package, at least contains information on a possible sweetening agent in the chewing gum and preferably also on other possible additives in the chewing gum.

38. A package according to claim 19, where the information not related to the confectionery and being provided on the inner surface of the package, at least contains information directed towards fields of interest of youth from 10-15 to 20-25 years of age comprising at least one of sport, music, film, education, transportation, health and electronic products.

39. A package according to claim 19, where the information not related to the confectionery and being provided on the inner surface of the package, at least contains information directed towards fields of interest of mid-aged from 20-25 to 40-50 years of age comprising at least one of sport, music, film, news, holidays, cars, health, babies and children and electronic products.

40. A package according to claim 19, where the information not related to the confectionery and being provided on the inner surface of the package, at least contains information directed towards fields of interest of elderly from 40-50 years of age or older comprising at least one of music, history, news, holidays, cars and electronic products.
